(19) United States
(12) Patent Application Publication
(10) Pub. No.: US 2026/0196840 A1
(43) Pub. Date: Jul. 9, 2026

(54) MICROGRID AND VIRTUAL INERTIA COORDINATED CONTROL METHOD THEREOF

(71) Applicant: DELTA ELECTRONICS, INC., Taoyuan City (TW)

(72) Inventors: Wen-Ching CHANG, Taoyuan City (TW); Jen-Ming YANG, Taoyuan City (TW); Yi-Kuan KE, Taoyuan City (TW)

(21) Appl. No.: 19/196,759

(22) Filed: May 2, 2025

(30) Foreign Application Priority Data
Jan. 9, 2025 (CN) 202510032452.6

(51) Int. Cl. H02J 3/38

(52) U.S. Cl. CPC H02J 3/381; H02J 2101/22

(57) ABSTRACT

A microgrid is coupled to a utility grid, and includes a first converter resource device, a generator and a controller. The first converter resource device is configured to generate a first energy. The generator is configured to generate a second energy. The controller is coupled to and controls the first inverter resource device and the generator device. The controller is configured to: in response to frequency of the utility grid decreasing or increasing, set the microgrid to output at least one of the first energy and the second energy. The first energy is virtual inertia energy, and the second energy is non-virtual inertia energy.

### CROSS-REFERENCE TO RELATED APPLICATION

This application claims priority to China Application Serial Number 202510032452.6, filed Jan. 9, 2025, which is herein incorporated by reference in its entirety.

### BACKGROUND

### Field of Invention

This disclosure relates to a microgrid and control method thereof, and in particular to the microgrid that can provide virtual inertia and the virtual inertia coordinated control method thereof.

### Description of Related Art

With the changes in the power supply structure in recent years, the proportion of renewable energy power generation has increased, while the proportion of power generation from traditional generators and the number of operating units have decreased year by year. This phenomenon reduces the inertial energy provided by the power system and increases sensitivity of the power system to changes in load and generated electrical energy, and it causes to a decrease in the stability of the frequency.

How to stabilize the power supply and frequency of the power system by microgrid is an important issue that technicians in this field have to deal with.

### SUMMARY

The present disclosure provides a microgrid. The microgrid comprises a first converter resource device, an alternator, and a controller. The first converter resource device is configured to generate a first energy. The generator device is configured to generate a second energy. The controller is coupled to and controlling the first converter resource device and the generator device, configured to: in response to a decrease or increase in the frequency of the utility grid, set the microgrid to output at least one of the first energy and the second energy, wherein the first energy is virtual inertia energy, and the second energy is non-virtual inertia energy.

The present disclosure provides a virtual inertia coordinated control method of a microgrid. The microgrid is coupled to a utility grid, and the virtual inertia coordinated control method comprising: by a first converter resource device, generating a first energy; by a generator device, generating a second energy; and in response to a decrease or increase in the frequency of the utility grid, outputting at least one of the first energy and the second energy. The first energy is virtual inertia energy, and the second energy is non-virtual inertia energy.

According to the embodiments of the present disclosure, the microgrid and the virtual inertia coordinated control method disclosed in this disclosure can stably provide inertial energy to the utility grid by the converter resource device and the generator device, thereby achieving the beneficial technical effect of enhancing the resilience of the power system.

### BRIEF DESCRIPTION OF THE DRAWINGS

FIG. 1 is a schematic diagram of a microgrid according to an embodiment of the present disclosure.

FIG. 2 is a flow chart of a virtual inertia coordinated control method according to an embodiment of FIG. 1.

FIG. 3 is a schematic diagram of a microgrid according to an embodiment of the present disclosure.

FIG. 4 is a flow chart of a virtual inertia coordinated control method according to an embodiment of FIG. 3.

### DETAILED DESCRIPTION

The embodiments are described in detail below with reference to the appended drawings to better understand the aspects of the present disclosure. However, the provided embodiments are not intended to limit the scope of the disclosure, and the description of the structural operation is not intended to limit the order in which they are performed. Any device that has been recombined by components and produces an equivalent function is within the scope covered by the disclosure.

The terms used in the entire specification and the scope of the patent application, unless otherwise specified, generally have the ordinary meaning of each term used in the field, the content disclosed herein, and the particular content.

The terms “coupled” or “connected” as used herein may mean that two or more elements are directly in physical or electrical contact, or are indirectly in physical or electrical contact with each other. It can also mean that two or more elements interact with each other.

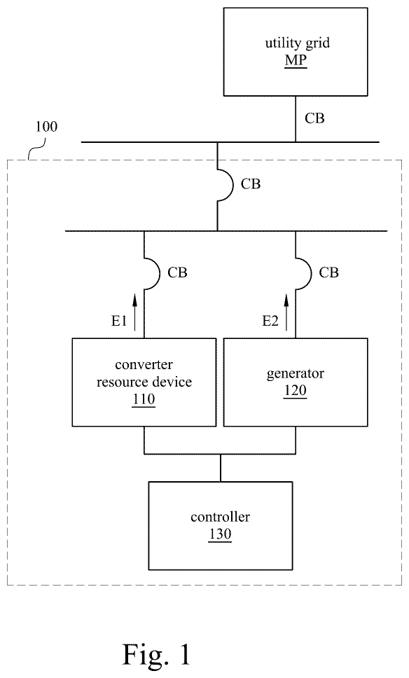

Referring to FIG. 1, FIG. 1 is a schematic diagram of a t microgrid 100 according to an embodiment of the present disclosure. In the embodiment of FIG. 1, the microgrid 100 is coupled to a utility grid MP by a circuit breaker CB. The microgrid 100 includes a converter resource device 110, a generator 120, and a controller 130.

The utility grid MP may be a well-known power system for providing electricity with stable voltage and frequency (i.e., 110 volts, 60 Hz) to the urban area. Both the converter resource device 110 and the generator 120 can be connected to the utility grid MP through circuit breaker CB.

The converter resource device 110 can be either a solar power plant or an energy storage system, and the “energy storage system” mentioned in the present disclosure can be a battery-type energy storage system. The converter resource device 110 can generate the energy E1. And since the converter resource device 110 is a solar power plant or energy storage system, the energy E1 should be virtual inertia energy.

The generator 120 may be a diesel generator, a biomass generator, a hydroelectric generator, a gas turbine generator, or any well-known generator that generates inertial energy (or “non-virtual inertia energy”). The generator 120 can generate energy E2, therefore, the energy E2 should be non-virtual inertia energy.

The controller 130 is coupled to the converter resource device 110 and the generator 120. The controller 130 may detect the frequency of the utility grid MP by a measuring device (i.e., a power meter but not limited to such a device). When the power supply of the utility grid is insufficient, the frequency of the utility grid may decrease from the rated frequency of the power system (for example, 60 Hz). And when the frequency of the utility grid MP decreases by a certain amplitude (for example, from 60 Hz to 59.5 Hz, this disclosure does not limit the specific value of the amplitude), or when the power supply of the utility grid is in excess, the frequency of the utility grid may increase from the rated frequency of the power system (for example, 60 Hz); and when the frequency of the utility grid MP increases by a certain amplitude (for example, from 60 Hz to 60.5 Hz, this disclosure does not limit the specific value of the amplitude), the controller 130 can enable the microgrid 100 to output at least one of energy E1 and energy E2, provide energy to the utility grid to stabilize the power supply of the utility grid, reduce the rate of change of the frequency of the utility grid MP, and restore the frequency of the utility grid MP to the rated frequency of the power system.

In an embodiment, if the converter resource device 110 is a solar power plant, the energy E1 is generated based on solar energy virtual inertia power P_{PV_VI}(t). The calculation method of the solar energy virtual inertia power P_{PV_VI}(t) is shown in the following formula <1>:

$${P}_{PV\_VI} ( t ) = - \frac{2 {H}_{PV} ( t ) \times {α}_{PV} \times {S}_{PV} \times {β}_{MPPT} ( t )}{{f}_{grid}} \frac{d}{dt} {f}_{grid} ( t ) \qquad Formula < 1 >$$

In formula <1>, “P_{PV_VI}(t)” is the solar virtual inertia power at a specific time t. “H_{PV}(t)” is the solar energy virtual inertia constant at a specific time t, and the setting range of the constant is between 0 and the virtual inertia constant maximum value H_{IBR_Max} that customized by this disclosure, so as to enable the controller 130 to adjust the energy E1 of the converter resource device 110. “α_{PV}” is the virtual inertia power utilization rate of the solar power plant, and its value is 0%~100%, and this disclosure is not limited α_{PV} to the specific percentage. “S_{PV}” is the equipment capacity of solar power plant, and its quantifier is million volt-ampere (MVA). “β_{MPPT}(t)” is the maximum power point tracking that the solar power plant can generate at a specific time t, and its value is 0%~100% (for example, when the time is noon and the sunlight is the strongest, the solar power plant can generate the most solar energy and the maximum power tracking percentage is close to 100%, while when the sky is dark, the solar power plant cannot generate electricity, so the maximum power point tracking β_{MPPT}(t) becomes 0%). “f_{grid}” is the frequency of the utility grid MP,

$$\frac{d}{dt} {f}_{grid} ( t )$$

is the changing rate of the grid frequency.

Based on formula <1>, when converter resource device 110 is a solar power plant, the amount of the energy E1 at the specific time t can be calculated as shown in formula <2> below:

$${E}_{{PV}_{VI}} ( t ) = {H}_{PV} ( t ) \times {α}_{PV} \times {S}_{PV} \times {β}_{MPPT} ( t ) \qquad Formula < 2 >$$

In another embodiment, if the converter resource device 110 is an energy storage system, the energy E1 is generated based on the energy storage system virtual inertia power P_{B_VI}(t). The calculation method of the energy storage system virtual inertia power P_{B_VI}(t) is shown in the following formula <3>:

$${P}_{B\_VI} ( t ) = - \frac{2 {H}_{B} ( t ) \times {α}_{B} \times {S}_{B}}{{f}_{grid}} \frac{d}{dt} {f}_{grid} ( t ) \qquad Formula < 3 >$$

In formula <3>, “P_{B_VI}(t)” is the energy storage system virtual inertia power at a specific time t. “H_{B}(t)” is the energy storage system virtual inertia constant at the specific time t, and the setting range of the constant is between 0 and the maximum value of the virtual inertia constant H_{IBR_Max} that customized by this disclosure, so as to enable the controller 130 to adjust the energy E1 of the converter resource device 110. “α_{B}” is the virtual inertia power utilization rate of the energy storage system, and its value is 0%~100%, and this disclosure is not limited α_{B} to the specific percentage. “S_{B}” is the equipment capacity of the energy storage system, and its quantifier is MVA.

Based on formula <3>, when converter resource device 110 is an energy storage system, the amount of the energy E1 at the specific time t can be calculated, as shown in formula <4> below:

$${E}_{B\_VI} ( t ) = {H}_{B} ( t ) \times {α}_{B} \times {S}_{B} \qquad Formula < 4 >$$

According to the above embodiments, no matter the converter resource device 110 is a solar power plant or an energy storage system, the controller 130 may be limited by the maximum value of the virtual inertia constant H_{IBR_Max} when adjusting the energy E1. Through the power upper limit value P_{IBR_Max}, the virtual inertia constant maximum value H_{IBR_Max} mentioned above can be obtained. The maximum value of the virtual inertia constant H_{IBR_Max} is calculated as shown in the following formula <5>:

$${H}_{IBR\_Max} = \frac{{P}_{IBR\_Max}}{2 {S}_{IBR} \vert \frac{d}{dt} {f}_{grid\_Max} ( t ) \vert} \qquad Formula < 5 >$$

In formula <5>, “H_{IBR_Max}” is the virtual inertia constant upper limit value of converter resource device 110. “P_{IBR_Max}” is the power upper limit value of converter resource device 110. “S_{IBR}” is the device capacity of converter resource device 110.

$$\vert \frac{d}{dt} {f}_{grid\_Max} ( t ) \vert$$

is the maximum frequency changing rate of the frequency of the utility grid MP.

As for the energy E2 of the generator 120, its calculation method is shown in the following formula <6>:

$$E 2 = {H}_{G} {S}_{G} \qquad Formula < 6 >$$

In formula <6>, “SG” is the equipment capacity of the generator 120, “HG” is the inertia constant of generator 120.

The controller 130 in FIG. 1 can monitor the utility grid MP and the microgrid 100 at the same time, and adjust the magnitude of the energies E1 and E2 by the contents of formulas <1> to <6>. In summary, microgrid 100 can stabilize the inertial energy of the utility grid MP, to achieve the beneficial technical effect of strengthening the resilience of the power system.

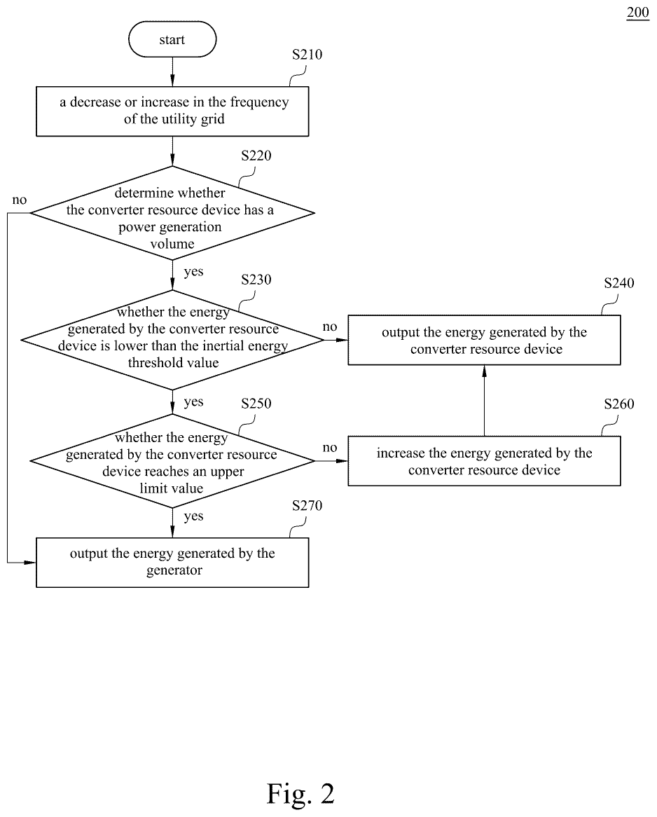

Refer to FIGS. 1 and 2. FIG. 2 is a flow chart of a virtual inertia coordinated control method 200 according to an embodiment of FIG. 1. The virtual inertia coordinated control method 200 can be configured to determine whether the microgrid 100 in FIG. 1 outputs energies E1 and E2 and to adjust the magnitude of the energy E1.

In step S210, the controller 130 may detect a decrease or increase in the frequency of the utility grid MP by a measuring device. Specifically, the controller 130 detects that the power supply frequency of the utility grid MP decreases or increases by a certain amplitude, as described above, and then executes step S220.

In step S220, the controller 130 may determine whether the converter resource device 110 has a power generation volume. If the converter resource device 110 is a solar power plant, and its maximum power point tracking β_{MPPT}(t) is not 0%, which means that the solar power plant (converter resource device 110) can generate electricity and has the power generation volume. If the converter resource device 110 is an energy storage system, its state of charge (SoC) can be used for power supply if it is not lower than the lower limit (i.e., having the power generation volume). By the way, when the state of charge reaches the lower limit, it means that the converter resource device 110 is not able to supply power, and this disclosure does not limit the specific value of the lower limit. When the converter resource device 110 has the power generation volume, step S230 is executed; when converter resource device 110 does not have the power generation volume, step S270 is executed.

In step S230, the controller 130 may determine whether the energy E1 generated by the converter resource device 110 is lower than the inertial energy threshold value E_{Mg}(t). The inertial energy threshold value E_{Mg}(t) is estimated based on the frequency changing rate regulation of the utility grid MP, the power changing value of the most serious power generation tripping accident at a specific time t, and the inertial energy provided by microgrid 100. In short, the inertial energy threshold value E_{Mg}(t) can be regarded as the energy value required by the microgrid 100 when the frequency suppresses the frequency changing rate and returns to the rated frequency during the utility gird MP matching the frequency changing rate regulations. When the energy E1 is higher than or equal to the inertial energy threshold value E_{Mg}(t), it means that the current energy E1 can provide the energy value required by the above utility gird MP independently. At this time, step S240 can be performed next. When the energy E1 is lower than the inertial energy threshold value E_{Mg}(t), step S250 is executed.

In step S240, microgrid 100 may output the energy E1 generated by the converter resource device 110.

In step S250, the controller 130 may determine whether the energy E1 generated by the converter resource device 110 reaches an upper limit value. The upper limit value of energy E1 can be determined by the power upper limit value P_{IBR_Max} and the maximum value of the virtual inertia constant H_{IBR_Max} mentioned above. When the energy E1 does not reach the upper limit value, step S260 is executed; when the energy E1 has reached the upper limit value, the converter resource device 110 outputs the energy E1 that has reached the upper limit value, and step S270 is executed.

In step S260, the controller 130 may increase the energy E1 generated by the converter resource device 110. Specifically, the controller 130 may increase the energy E1 by increasing the virtual inertia constant of converter resource device 110 (i.e., the solar energy virtual inertia constant H_{PV}(t) in formulas <1> and <2>, or the energy storage system virtual inertia constant H_{B}(t) in formulas <3> and <4>). After the energy E1 is increased, step S240 is then executed.

In step S270, the microgrid 100 may output the energy E2 generated by the generator 120. Specifically, there may be two situations for executing step S270: first, the converter resource device 110 does not have the power generation volume, so the energy value required by the utility grid MP is supplemented by the energy E2 generated by the generator 120, and the output electrical energy of the microgrid 100 is only the energy E2; second, although the converter resource device 110 has the power generation volume, the energy E1 of the converter resource device 110 has reached the upper limit value but is still lower than the inertial energy threshold value E_{Mg}(t), the microgrid 100 can activate the generator 120, and the output electrical energy of the microgrid 100 is the energy E2 and the energy E1 that has reached the upper limit value.

By the virtual inertia coordinated control method 200, it can be clearly understood how the microgrid 100 in FIG. 1 regulates the converter resource device 110 and the generator 120 to output at least one of the energies E1 and E2.

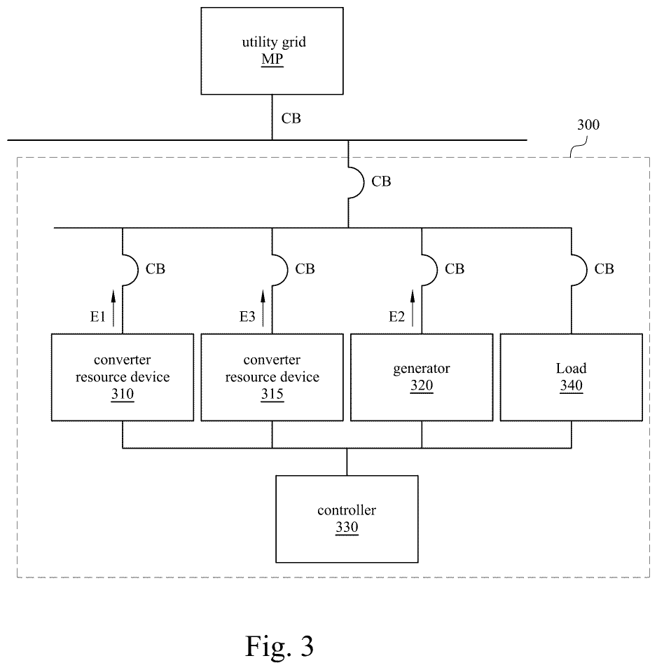

Referring to FIG. 3, FIG. 3 is a schematic diagram of a microgrid 300 according to an embodiment of the present disclosure. In the embodiment of FIG. 3, the microgrid 300 is coupled to the utility grid MP through the circuit breaker CB. The microgrid 300 includes converter resource devices 310, 315, a generator 320, a controller 330, and a load 340.

The converter resource devices 310 and 315 of the microgrid 300 may correspond to converter resource device 110 in FIG. 1. It is worth noting that converter resource device 310 can be one of a solar power plant and an energy storage system, and converter resource device 315 can be the other of the solar power plant and the energy storage system.

In an embodiment, the converter resource device 310 may be a solar power plant, and circuit characteristics of the converter resource device 310 may correspond to the embodiment in which the converter resource device 110 in FIG. 1 is a solar power plant. In this embodiment, the converter resource device 315 may be an energy storage system, and the circuit characteristics of converter resource device 315 may correspond to the embodiment in which the converter resource device 110 in FIG. 1 is an energy storage system.

In the above embodiment, the energy E1 generated by the converter resource device 310 and the energy E3 generated by the converter resource device 315 are both virtual inertia energies.

The generator 320 of the microgrid 300 may correspond to the generator 120 of FIG. 1. The energy E2 generated by generator 320 corresponds to the energy E2 in FIG. 1, and both are inertial energy (non-virtual inertia energy).

The controller 330 of the microgrid 300 may correspond to the controller 130 of the microgrid 100. The difference between the two is that the controller 330 is coupled to the converter resource devices 310 and 315, the generator 320 and the load 340. When the frequency of the utility grid MP decreases or increases by a certain amplitude, the controller 330 can enable the microgrid 300 to output at least one of the energies E1, E2, and E3.

The controller 330 may adjust the energy E1 generated by the converter resource device 310 according to the above formulas <1> and <2>. The controller 330 may adjust the energy E3 generated by the converter resource device 315 according to the above formulas <3> and <4>. Furthermore, the controller 330 may adjust the energy E2 generated by the generator 320 according to the above formula <6>.

When the controller 330 adjusts the energy E1 generated by the converter resource device 310, it would be limited by the maximum value of the virtual inertia constant H_{IBR_Max1}. The maximum value of the virtual inertia constant H_{IBR_Max1} of the energy E1 can be obtained through the power upper limit value P_{IBR_Max1}.

When the controller 330 adjusts the energy E3 generated by the converter resource device 315, it would be limited by the maximum value of the virtual inertia constant H_{IBR_Max2}. The maximum value of the virtual inertia constant H_{IBR_Max2} of the energy E3 can be obtained through the power upper limit value P_{IBR_Max2}.

The power upper limit values P_{IBR_Max1} and P_{IBR_Max2} of microgrid 300 may both correspond to the power upper limit value P_{IBR_Max} of the above formula <5>, and the virtual inertia constant maximum value H_{IBR_Max1} and the virtual inertia constant maximum value H_{IBR_Max2} of the microgrid 300 may both correspond to the virtual inertia constant maximum value H_{IBR_Max} of the above formula <5>. However, in this embodiment, the power upper limit value P_{IBR_Max1} may be the same as or different from the power upper limit value P_{IBR_Max2}, and this disclosure is not limited thereto; correspondingly, the virtual inertia constant maximum value H_{IBR_Max1} may also be the same as or different from the virtual inertia constant maximum value H_{IBR_Max2}.

It is worth mentioning that when the frequency of the utility gird MP decreases or increases by a certain amplitude, if the power generation volume of the solar power plant (for example, converter resource device 310) of this embodiment can provide the energy value required by the utility grid MP independently, the controller 330 can reduce the energy storage system virtual inertia constant H_{B}(t) of the energy storage system (for example, converter resource device 315) to 0, so that the energy storage system does not generate the energy E3, and the energy storage system can perform other beneficial functions, such as voltage strategies for reactive power compensation, frequency compensation for droop control and energy regulation strategies for peak shaving and valley filling, or execute strategies such as adjusting the battery state of charge, thereby the battery life and the utilization rate of the energy storage system can be improved.

In this embodiment, the load 340 is configured to represent the internal infrastructure in the microgrid 300.

Compared to the microgrid 100 in FIG. 1, the microgrid 300 in FIG. 3 further includes a plurality of converter resource devices, so that the inertial energy of the utility grid MP can be more stable in the embodiment of FIG. 3.

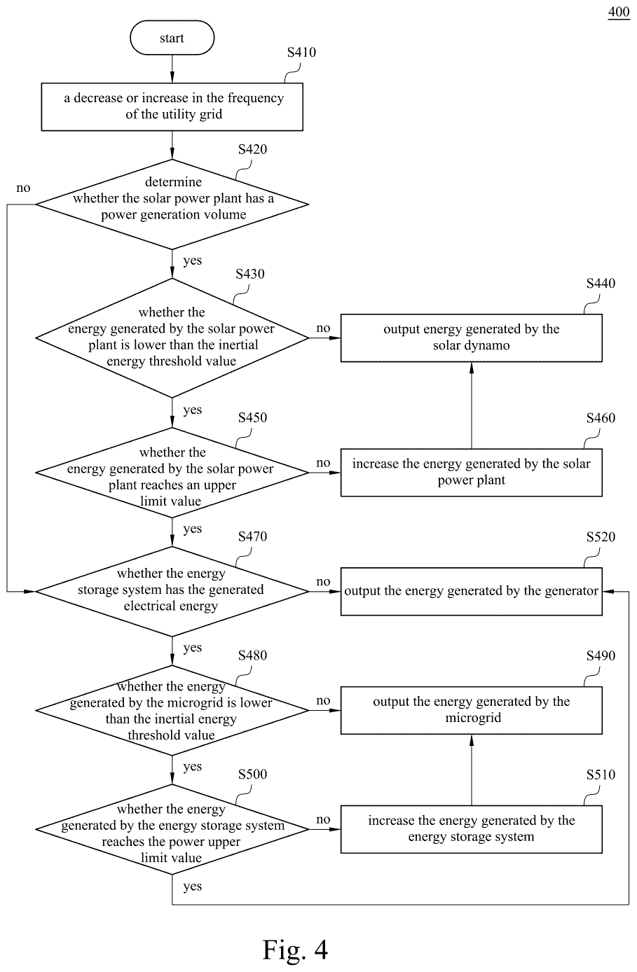

Refer to FIGS. 3 and 4 simultaneously. FIG. 4 is a flow chart of a virtual inertia coordinated control method 400 according to an embodiment of FIG. 3. The virtual inertia coordinated control method 400 can be configured to determine whether the microgrid 300 in FIG. 3 outputs the energy E1, E2, E3 and adjust the magnitude of the energy E1, E3.

In step S410, the controller 330 may detect a decrease or increase in the frequency of the utility grid MP through a measuring device, and then execute step S420.

In step S420, controller 330 may determine whether the solar power plant (i.e., the converter resource device 310) has a power generation volume. If the maximum power point tracking β_{MPPT}(t) of converter resource device 310 is not 0%, it means that the converter resource device 310 can receive sunlight and provide the power generation volume. When the converter resource device 310 has the power generation volume, execute step S430; when converter resource device 310 does not have the power generation volume, execute step S470.

In step S430, the controller 330 may determine whether the energy E1 generated by the solar power plant (the converter resource device 310) is lower than the inertial energy threshold value E_{Mg}(t). Similar to the relevant content of virtual inertia coordinated control method 200 mentioned above, the inertial energy threshold value E_{Mg}(t) can be regarded as the energy value required to restore the frequency of the utility grid MP to the rated frequency of the power system. When the energy E1 is higher than or equal to the inertial energy threshold value E_{Mg}(t), execute step S440; when the energy E1 is lower than the inertial energy threshold value E_{Mg}(t), execute step S450.

In step S440, the microgrid 300 may output energy E1 generated by the solar power plant (the converter resource device 310).

In step S450, the controller 330 may determine whether the energy E1 generated by the solar power plant (the converter resource device 310) reaches an upper limit value. The upper limit value of energy E1 can be determined by the power upper limit value P_{IBR_Max} and the maximum value of the virtual inertia constant H_{IBR_Max}1 mentioned above. When the energy E1 does not reach the upper limit value, execute step S460; when the energy E1 has reached the upper limit value, the converter resource device 310 outputs the energy E1 that has reached the upper limit value, and then executes step S470.

In step S460, the controller 330 may increase the energy E1 generated by the solar power plant (the converter resource device 310). Specifically, the controller 330 can increase the energy E1 by improving the solar energy virtual inertia constant H_{PV}(t) contained in formulas <1> and <2>. After the energy E1 is increased, execute step S440.

In step S470, the controller 330 may determine whether the energy storage system (converter resource device 315) has the power generation volume. If the reserve power of converter resource device 315 is not lower than the lower limit, it can be used for power supply (i.e., it has the power generation volume). By the way, when the solar power plant reaches the lower limit, it means that the converter resource device 315 does not supply power, and this disclosure does not limit the specific value of the lower limit. When the converter resource device 315 has the power generation volume, execute step S480; when converter resource device 315 does not have the power generation volume, execute step S520.

In step S480, the controller 330 may determine whether the energy generated by the microgrid 300 is lower than the inertial energy threshold value E_{Mg}(t). If the solar power plant (converter resource device 310) has the power generation volume, the energy generated by the microgrid 300 in this step is the energy E1 of the converter resource device 310 that has reached the upper limit value and the energy E3 of the converter resource device 315. If the solar power plant (converter resource device 310) does not generate electrical energy, then the energy generated by the microgrid 300 in this step is only the energy E3 of the converter resource device 315. When the energy generated by the microgrid 300 is higher than or equal to the inertial energy threshold value E_{Mg}(t), execute step S490; when the energy generated by the microgrid 300 is lower than the inertial energy threshold value E_{Mg}(t), execute step S500.

In step S490, the microgrid 300 may output the energy generated by itself. As described above, the energy that can be output by the microgrid 300 can be a sum of the energy E1 and the energy E3 or the energy E3 independently.

In step S500, the controller 330 may determine whether the energy E3 generated by the energy storage system (converter resource device 315) reaches the power upper limit value P_{IBR_Max2}. The upper limit value of energy E3 can be determined by the upper limit value of power P_{IBR_Max2} and the maximum value of virtual inertia constant H_{IBR_Max}2 mentioned above. When the energy E3 does not reach the upper limit value, execute step S510; when the energy E3 has reached the upper limit value, the converter resource device 315 outputs the energy E3 that has reached the upper limit value, and executes step S520.

In step S510, the controller 330 may increase the energy E3 generated by the energy storage system (converter resource device 315). Specifically, the controller 330 can increase the energy E3 by increasing the energy storage system virtual inertia constant H_{B}(t) contained in formulas <3> and <4>. After the energy E3 is increased, then execute step S490.

In step S520, the microgrid 300 may output the energy E2 generated by the generator 320. Specifically, the situations in which step S520 is performed may be as follows:

First, the converter resource device 310 and the converter resource device 315 do not have the power generation volume. In this case, the output electrical energy of the microgrid 300 is only the energy E2 generated by the generator.

Second, the converter resource device 310 has the power generation volume, and the converter resource device 315 does not have the power generation volume. In this case, although the converter resource device 310 has the power generation volume, the energy E1 of converter resource device 310 has reached the upper limit value but is still lower than the inertial energy threshold value E_{Mg}(t). The output electric energy of the microgrid 300 is a sum of the energy E1 reaching the upper limit value and the energy E2.

Third, the converter resource device 310 does not have the power generation volume, and the converter resource device 315 has the power generation volume. In this case, although converter resource device 315 has the power generation volume, the energy E3 of converter resource device 315 has reached the upper limit value but is still lower than the inertial energy threshold value E_{Mg}(t). The output electric energy of the microgrid 300 is a sum of the energy E3 reaching the upper limit value and the energy E2.

Fourth, the converter resource device 310 and the converter resource device 315 both have the power generation volume. In this case, the output electric energy of the microgrid 300 is the energy E1 reaching the upper limit value, the energy E2, and the energy E3 reaching the upper limit value.

In summary, the microgrid and virtual inertia coordinated control method disclosed in this disclosure can stabilize the inertial energy of the utility grid by the converter resource device and the generator, thereby achieving the beneficial technical effect of enhancing the resilience of the power system.

Although the present disclosure has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present disclosure without departing from the scope or spirit of the invention. In view of the foregoing, it is intended that the present invention cover modifications and variations of this invention provided they fall within the scope of the following claims.

What is claimed is:

1. A microgrid, coupled to a utility grid, comprising:
a first converter resource device, configured to generate a first energy;
a generator, configured to generate a second energy; and
a controller, coupled to and controlling the first converter resource device and the generator, configured to:
in response to a decrease or an increase in a frequency of the utility grid, set the microgrid to output at least one of the first energy and the second energy,
wherein the first energy is virtual inertia energy, and the second energy is non-virtual inertia energy.

2. The microgrid of claim 1, wherein the controller is further configured to:
in response to the first energy being not lower than an inertial energy threshold value, set the microgrid to output the first energy.

3. The microgrid of claim 1, wherein the controller is further configured to:
in response to the first energy being lower than an inertial energy threshold value and the first energy not reaching a first upper limit value, increase the first energy and set the microgrid to output the first energy after increased; and
in response to the first energy being lower than the inertial energy threshold value and the first energy reaching the first upper limit value, set the microgrid to output the first energy and the second energy.

4. The microgrid of claim 1, wherein the first converter resource device is one of a solar power plant and an energy storage system.

5. The microgrid of claim 1, further comprising:
a second converter resource device, configured to generate a third energy,
wherein the third energy is virtual inertia energy,
wherein the controller is further configured to:
in response to the decrease or the increase in the frequency of the utility grid, set the microgrid to output at least one of the first energy, the second energy and the third energy.

6. The microgrid of claim 5, wherein the first converter resource device is one of a solar power plant and an energy storage system, and the second converter resource device is another one of the solar power plant and the energy storage system.

7. The microgrid of claim 5, wherein the controller is further configured to:
in response to the first energy being lower than an inertial energy threshold value, the first energy reaching a first upper limit value, and the second converter resource device having a power generation volume, set the microgrid to output the first energy and the third energy.

8. The microgrid of claim 5, wherein the controller is further configured to:
in response to a sum of the first energy and the third energy being lower than an inertial energy threshold value, the first energy reaching a first upper limit value, and the third energy not reaching a second upper limit value, increase the third energy and set the microgrid to output the first energy and the third energy after increased; and
in response to a sum of the first energy and the third energy being lower than the inertial energy threshold value, the first energy reaching the first upper limit value, and the third energy reaching the second upper limit value, set the microgrid to output the first energy, the second energy, and the third energy.

9. A virtual inertia coordinated control method of a microgrid, wherein the microgrid is coupled to a utility grid, and the virtual inertia coordinated control method comprising:
by a first converter resource device, generating a first energy;
by a generator, generating a second energy; and
in response to a decrease or an increase in a frequency of the utility grid, outputting at least one of the first energy and the second energy,
wherein the first energy is virtual inertia energy, and the second energy is non-virtual inertia energy.

10. The virtual inertia coordinated control method of claim 9, further comprising:
in response to the first energy being not lower than an inertial energy threshold value, outputting the first energy.

11. The virtual inertia coordinated control method of claim 9, further comprising:
in response to the first energy being lower than an inertial energy threshold value and the first energy not reaching a first upper limit value, increasing the first energy and outputting the first energy after increased; and
in response to the first energy being lower than the inertial energy threshold value and the first energy reaching the first upper limit value, outputting the first energy and the second energy.

12. The virtual inertia coordinated control method of claim 9, wherein the first converter resource device is one of a solar power plant or an energy storage system.

13. The virtual inertia coordinated control method of claim 9, further comprising:
by a second converter resource device, generating a third energy; and
in response to the decrease or the increase in the frequency of the utility grid, outputting at least one of the first energy, the second energy and the third energy,
wherein the third energy is virtual inertia energy.

14. The virtual inertia coordinated control method of claim 13, wherein the first converter resource device is one of a solar power plant and an energy storage system, and the second converter resource device is another one of the solar power plant and the energy storage system.

15. The virtual inertia coordinated control method of claim 13, further comprising:
in response to the first energy being lower than an inertial energy threshold value, the first energy reaching a first upper limit value, and the second converter resource device having a power generation volume, outputting the first energy and the third energy.

16. The virtual inertia coordinated control method of claim 13, further comprising:
in response to a sum of the first energy and the third energy being lower than an inertial energy threshold value, the first energy reaching a first upper limit value, and the third energy not reaching a second upper limit value, increasing the third energy and outputting the first energy and the third energy after increased; and
in response to a sum of the first energy and the third energy being lower than the inertial energy threshold value, the first energy reaching the first upper limit value, and the third energy reaching the second upper limit value, outputting the first energy, the second energy, and the third energy.
